(19) United States
(12) Patent Application Publication
(10) Pub. No.: US 2021/0326700 A1
(43) Pub. Date: Oct. 21, 2021

(54) NEURAL NETWORK OPTIMIZATION

(71) Applicant: Genotaur, Inc., San Diego, CA (US)

(72) Inventors: Sheldon BROWN, San Diego, CA (US); Robert TWOMEY, San Diego, CA (US); Douglas R. JOHNSON, San Diego, CA (US); Zifeng LI, San Diego, CA (US)

(21) Appl. No.: 17/199,976

(22) Filed: Mar. 12, 2021

Related U.S. Application Data
(60) Provisional application No. 62/988,823, filed on Mar. 12, 2020.

(51) Int. Cl. G06N 3/08; G06N 3/04

(52) U.S. Cl. CPC G06N 3/08; G06N 3/0454

(57) ABSTRACT

Optimization of existing neural networks and optimization of newly defined neural networks is provided. The system starts from an existing neural network with a known state or from a set of desired characteristics for a newly defined neural network and creates a first generation of candidate neural networks with random variations of architectural structures and hyperparameters. Fitness functions are established to evaluate the candidate neural networks. Each candidate neural network is trained and operated and then evaluated using the fitness functions. Top performing architectural structures and hyperparameters are identified and used to create a second generation of candidate neural networks that trained, operated and evaluated. The process iteratively continues until an optimized candidate neural network is determined.

### RELATED APPLICATIONS

This application claims priority to U.S. Provisional Application, 62/988,823, filed Mar. 12, 2020, entitled “NEURAL NETWORK OPTIMIZATION,” the contents of which is incorporated herein by reference in its entirety.

### BACKGROUND

### Field of the Invention

The present disclosure generally relates to neural networks and more specifically relates to neural network design and optimization using genetic algorithms.

### Related Art

An artificial neural network (“ANN” or “NN” or “neural network”) is a computing system that is loosely modeled loosely after biological neural networks that are part of the human brain. Neural networks are typically trained to perform a specific task through analysis of significant amounts of known data. Once a neural network has been sufficiently trained, unknown data can be provided to the neural network and the neural can perform the task by analyzing the unknown data.

The structure of a neural network comprises multiple layers, which include an input layer, any number of intermediate (also referred to as “hidden”) layers, and an output layer. Each layer may have a number of nodes, and each node is configured to receive an input, which may be weighted, and perform a particular function or task and, in most cases, provide an output. A node may receive multiple inputs from multiple sources and may provide multiple outputs to multiple recipients.

Before the training of a neural network may take place, the neural network must be created. When a neural network is being created, certain characteristics of the neural network must be established in advance. Many of these characteristics are established using hyperparameters, which are parameters that have their values set before the training process of the neural network commences. Hyperparameters typically determine the architectural structure of a neural network, for example whether the neural network is considered to be Recurrent, Long/Short Term Memory (“LSTM”), Deep Convolutional, Deconvolutional, Generative Adversarial, or one of many other types of architectural structures. Hyperparameters also typically define neural network characteristics such as the number of hidden layers and the number of nodes in a particular layer.

A significant problem with the creation of neural networks is that it requires a skilled professional to manually select the structural architecture and establish the hyperparameters and their respective values. This process that is undertaken by the skilled professional has a significant impact on operational speed and success of the resulting neural network. Additionally, the selection of the structural architecture and setting of hyperparameters are constrained by the experience and skill of the professional(s) designing the neural network. Accordingly, many neural networks are created with a structural architecture and set of hyperparameters that ultimately generate suboptimal results. Therefore, what is needed is a system and method that overcomes these significant problems described above.

### SUMMARY

The present disclosure addresses the significant problems described above by using genetic algorithm methods to establish the architectural structure and set the values of the hyperparameters. In one method, a first set of candidate neural networks are initially created with random variations of architectural structures and hyperparameters. Additionally one or more fitness functions are established that characterize the desired functions of a desired neural network, for example, successful outcomes for the specific task that the neural network will be trained to perform. Each candidate neural network in the first set of candidate neural networks having the random variations of architectural structures and hyperparameters are then exercised and evaluated using the fitness functions. The architectural structures and hyperparameters of the candidate neural networks in the first set having the highest evaluations are then analyzed and a second set of candidate neural networks are created using variations of the characteristics of the most successful candidate neural networks from the first set of candidate neural networks.

Each candidate neural network in the second set of candidate neural networks having the selected architectural structures and hyperparameters are then exercised and evaluated using the fitness functions. The architectural structures and hyperparameters of the candidate neural networks in the second set having the highest evaluations are then analyzed and a third set of candidate neural networks are created using variations of the characteristics of the most successful candidate neural networks from the second set of candidate neural networks.

This process of creating, exercising, and evaluating may continue for any number of sets of candidate neural networks, with the result being the identification of an optimal structure for the desired neural network in accordance with the fitness function and an optimal set of hyperparameters and their respective values in accordance with the fitness function. In one embodiment, the fitness functions may change over time to evaluate the candidate neural networks using increasingly stringent criteria.

In one embodiment, the fitness functions may change over time to serially evaluate different and/or specific qualities of the candidate neural networks. Alternatively, multiple instantiations of the method may proceed in parallel using different fitness functions to evaluate different and/or specific qualities of the candidate neural networks. Using either the serial or parallel approach, over time, successful characteristics of separate evaluations of the candidate neural networks can be merged into a single candidate neural network for exercising and evaluating against one or more fitness functions corresponding to a desired neural network.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a flow diagram illustrating an example process for optimization of a neural network over multiple generations of automated revision and evaluation according to an embodiment;

FIG. 2 is a graph diagram illustrating an example progressive optimization of a various neural networks over multiple generations of automated revision and evaluation according to an embodiment;

FIGS. 3A-3B are graph diagrams illustrating an example progressive optimization of a densely connected neural network over multiple generations of automated revision and evaluation according to an embodiment;

FIGS. 4A-4B are graph diagrams illustrating an example progressive optimization of a convolutional neural network over multiple generations of automated revision and evaluation according to an embodiment;

FIGS. 5A-5B are graph diagrams illustrating an example progressive optimization of a hybrid long short-term memory and dense neural network over multiple generations of automated revision and evaluation according to an embodiment;

FIGS. 6A-6B are graph diagrams illustrating an example progressive optimization of a hybrid long short-term memory and convolutional neural network over multiple generations of automated revision and evaluation according to an embodiment;

FIG. 7 is a block diagram illustrating an example wired or wireless processor enabled device that may be used in connection with various embodiments described herein.

### DETAILED DESCRIPTION

Certain embodiments disclosed herein provide for systems and methods for neural network optimization. For example, one method disclosed herein generates candidate neural networks using one or more seed architectures and randomly selected hyperparameters and exercises the candidate neural networks based on genetic parameters. The performance of the candidate neural networks is subsequently analyzed to identify the top performing neural networks and hyperparameters. The characteristics of the top performing networks and their respective hyperparameters are then used to seed a second generation of candidate neural networks that are generated using desirable hyperparameters and random variations of the desirable hyperparameters. This process iterates until a desirable candidate neural network and its respective hyperparameters are determined.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

### Introduction

Embodiments described here use genetic algorithm methods to initially establish and subsequently vary the architectures and hyperparameters and their respective values for candidate neural networks. This includes creating at the outset many random variations of neural network characteristics an applying them to candidate neural networks. This process automatically produces a number of independent candidate neural networks whose efficacy is evaluated against any number of fitness functions that characterize desired functions of the neural network. Advantageously, candidate neural network characteristics (e.g., architecture and hyperparameter values) that are successful serve as the starting point from which any number of next generation candidate neural networks are created by randomly varying (mutating) the characteristics of the successful candidate neural networks from the previous generation. In one embodiment, the rate of variation is automatically applied based on the value of a genetic parameter. Additionally, the number of variations generated can be fixed by a genetic parameter or may be automatically modified over time under control of the system. The fitness functions can also change over time to evaluate different qualities of a candidate neural network, for example, a fitness function may change over time to become increasingly stringent. The set of genetic parameters determine the overall system characteristics, typically to achieve initial widespread diversity of candidate neural network structures, hyperparameters and types. Advantageously, over time the system automatically evolves a candidate neural network solution with specific characteristics are automatically derived through application of the automatic iterative process.

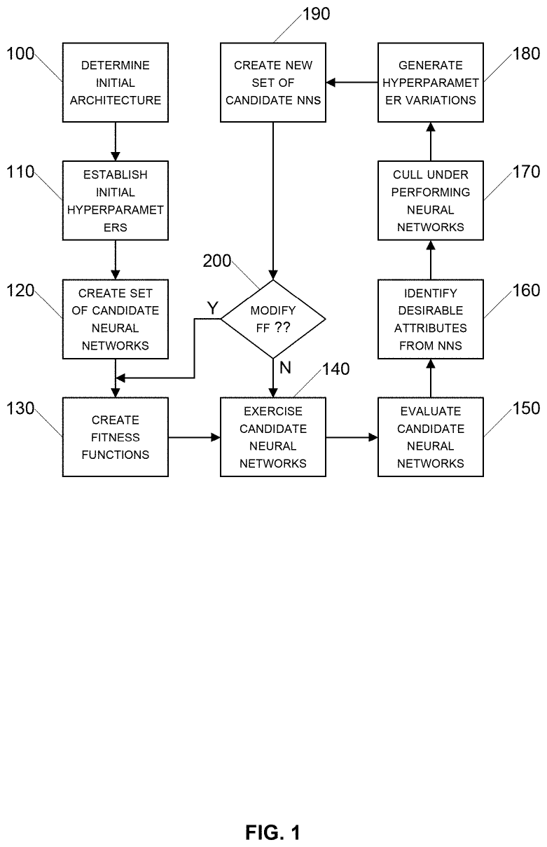

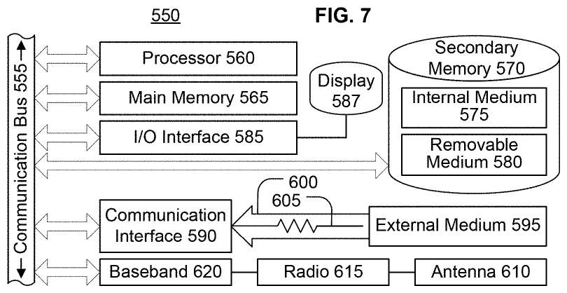

FIG. 1 is a flow diagram illustrating an example process for optimization of a neural network over multiple generations of automated revision and evaluation according to an embodiment. The illustrated embodiment may be carried out by a processor enabled system such as described in connection with FIG. 7. It will be understood that the order of the illustrated steps may be modified. Initially, in step 100 the system automatically determines one or more initial architectures for the candidate neural networks. The initial architectures may include convolutional (“CNN”), recurrent, long/short term memory (“LSTM”), Deep Convolutional (“Deep”), Deconvolutional, and Generative Adversarial, just to name a few. Other architectures may also be selected. In one embodiment, the initial architectures may be automatically selected by the system based, for example, on an analysis of data stored in genetic parameters. The genetic parameters may include data such as the purpose of the neural network (e.g., image processing, sequential data processing, etc.) and the system may automatically select the initial architecture(s) based on an analysis of the genetic parameters. Similarly, the number of architectures selected may also be governed by the genetic parameters.

Once the initial architectures have been determined, in step 110 the system establishes the initial hyperparameters for the candidate neural networks. In one embodiment, the genetic parameters are analyzed to determine characteristics of the initial hyperparameters. For example, the genetic parameters may be analyzed to determine the number of layers for a candidate neural network, the number of nodes of a layer for a candidate neural network, the kernel size, stride, and other characteristics of a neural network governed by hyperparameters. The initial hyperparameters that are established for the candidate networks do not have the same values for each candidate neural network. Advantageously, the values of the initial hyperparameters are automatically modified to create a broad range of alternative candidate neural networks with a broad mix of architectures and hyperparameter values. In an embodiment where only a single architecture is initially selected, the system automatically generates a variety of initial hyperparameter values so that the various candidate neural networks have a broad mix of different hyperparameter values.

Next, in step 120 an initial set of candidate neural networks is automatically created by the system. The initial candidate set of neural networks may include candidate neural networks having a variety of architectures and a variety of hyperparameter values. Any number of candidate neural networks may be created. Advantageously, the number of candidate neural networks that are created may by governed by one of the genetic parameters.

Next, in step 130, one or more fitness functions are created. The fitness functions are created in order to automatically analyze the performance of the candidate neural networks. A fitness function may correspond to overall performance of the candidate neural network or may correspond to one particular aspect of the candidate neural network.

Once the candidate neural networks, their respective hyperparameters, and the corresponding fitness functions have been automatically created, the system then automatically exercises the candidate neural networks as shown in step 140. Exercising the candidate neural networks includes both a training phase and an operation phase. Advantageously, the automatic exercising of the candidate neural networks may be governed by certain genetic parameters that may determine, for example, the amount of time spent in the training phase, the required accuracy of results performed on a specific test (e.g., numerical digit recognition from a set of known numerical digit images), the memory footprint of a candidate neural network, the compute resource utilized over a particular amount of time by a candidate neural network, and the speed of candidate neural network processing, just to name a few.

In one embodiment, certain genetic parameters can be specified as having base thresholds that advantageously evolve over generations such that a candidate neural network in a given network is evaluated against an increasing threshold. Similarly, evaluation of the candidate neural networks within a generation might be characterized by selecting the best performer against one or more outcomes, or by selecting the top percentage of performers from a set of tests, for example, the top 10% of a group of candidate neural networks. Additionally, the importance of various different qualities exhibited by the candidate neural networks may be weighted for evaluating the candidate neural networks in a generation, for example, 20% on memory size, 40% on accuracy, 20% on speed, and 20% on training time. Such a weighting may advantageously allow for calculation of a cumulative score for each candidate neural network and such cumulative scores may be considered during the evaluation of each respective candidate neural network.

After the candidate neural networks have been exercised, the performance of the candidate neural networks is automatically evaluated by the system, as illustrated in step 150. Evaluation of the performance of a candidate neural network may be carried out automatically by executing one or more fitness functions against the performance metrics of the candidate neural network, the output(s) of the candidate neural network, and/or other data collected about the performance of the candidate neural network overall. Similarly, evaluation of the performance of a candidate neural network may also include automatically executing one or more fitness functions to determine the effectiveness of individual hyperparameters of the candidate neural network.

After the candidate neural networks have been evaluated, the candidate neural networks are relatively ranked and high performing hyperparameters are identified. As shown in step 160, this results in the identification of desirable attributes from the candidate neural networks, including successful architectures and high performing hyperparameters. Next, in step 170, the underperforming neural networks from the first set of candidate neural networks are automatically culled from the first set of candidate neural networks. Additionally, the high performing hyperparameters from the first set of candidate neural networks are analyzed and a number of variations of these high performing hyperparameters are automatically generated in step 180. In one embodiment, the amount and range of variations of the high performing hyperparameters can be determined by a genetic parameter. For example, a certain percentage (e.g., 10%) of the high performing hyperparameters can be randomly mutated within 10% of the current value. Alternatively, a Gaussian distribution (or other algebraic function or other formula) may be applied to identify the high performing hyperparameters that will be mutated and the range of mutated values may also be randomly assigned or calculated by a formula that may impose constraints (e.g., within 10% of current value) or may not impose constraints.

Next in step 190, a new set of candidate neural networks is created. In one embodiment, the new set of candidate neural networks includes the top performing candidate neural networks form the prior set of candidate neural networks and a plurality of new candidate neural networks having a variety of different values for their respective hyperparameters and possibly also having a variety of different architectures.

In one embodiment, a genetic parameter or formula governs the number of candidate neural networks in a generation, for example by directly specifying the number of candidate neural networks or by calculating the number of candidate neural networks. Calculating the number of candidate neural networks may be accomplished as a function of the overall time, computational resource and memory footprint of the candidate neural network generation. Advantageously, the genetic parameter(s) governing the number of candidate neural networks in a generation may evolve over time in a fashion similar to the evolution of the hyperparameters themselves.

Next, in step 200, the system automatically evaluates if one or more fitness functions are to be modified and if so, then the method proceeds to step 130 for creation of the fitness functions, e.g., creating a new fitness function by modifying an existing fitness function, perhaps to make it more stringent, or alternatively by generating a entirely new fitness function, perhaps to evaluate a different characteristic of the candidate neural networks.

Advantageously, after the initial set of candidate neural networks and their respective hyperparameters and hyperparameter values are created and exercised and evaluated, a second generation set of candidate neural networks is generated based on the characteristics of the top performing candidate neural networks. This process of generating candidate neural networks and exercising them and evaluating them and generating a new set of candidate neural networks based on the top performance characteristics may automatically iterate until a single optimized candidate neural network has been identified based on the evaluation provided by the fitness functions. In this fashion, an optimized neural network can be automatically generated by the system, thereby saving significant man hours and resulting in a neural network that is very well suited for the specific task to be performed.

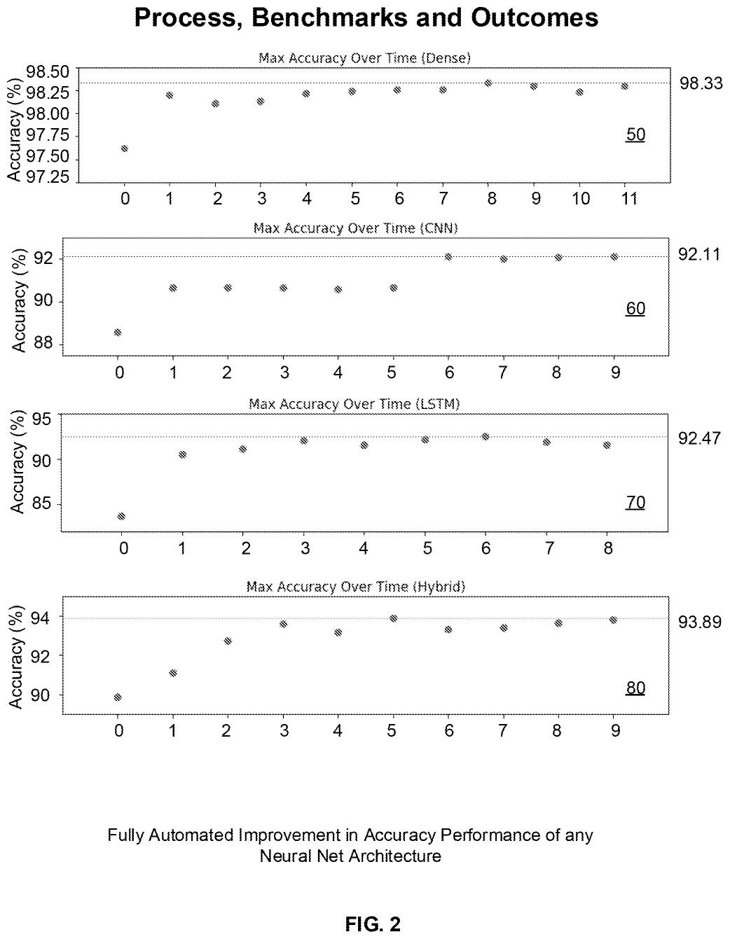

FIG. 2 is a graph diagram illustrating an example progressive optimization of a various neural networks over multiple generations of automated revision and evaluation according to an embodiment. In the illustrated embodiment, four different architectures of neural networks were evaluated, including a dense convolutional neural network 50, a convolutional neural network 60, a long/short term memory neural network 70, and a hybrid architecture neural network 80. For each of the four different architectures, the results of the automated progressive optimization over multiple generations resulted in an increase in accuracy and improved performance for the respective neural network architecture.

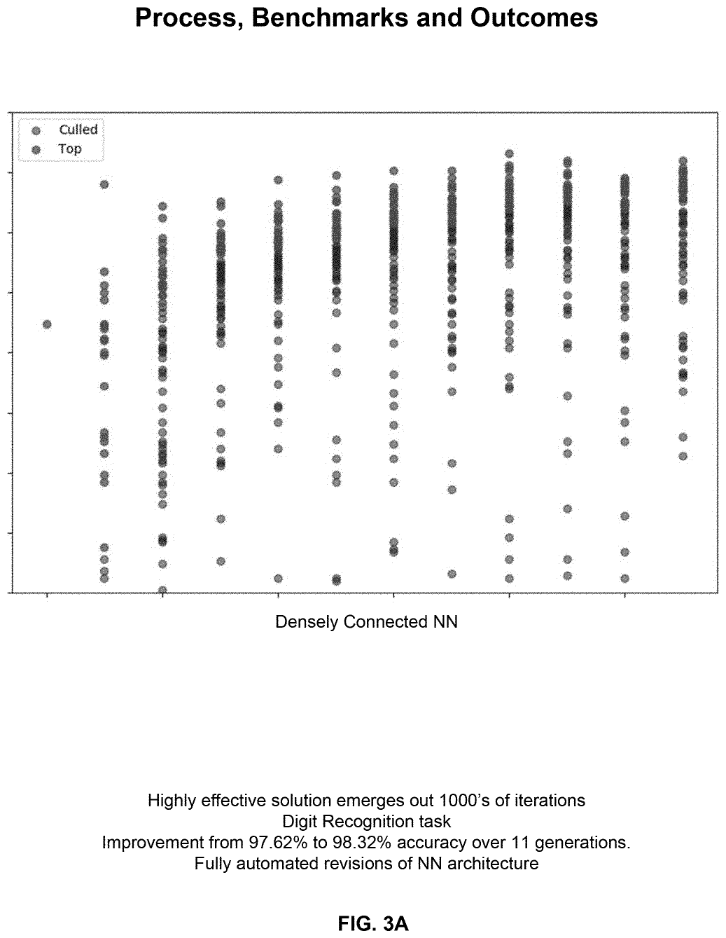

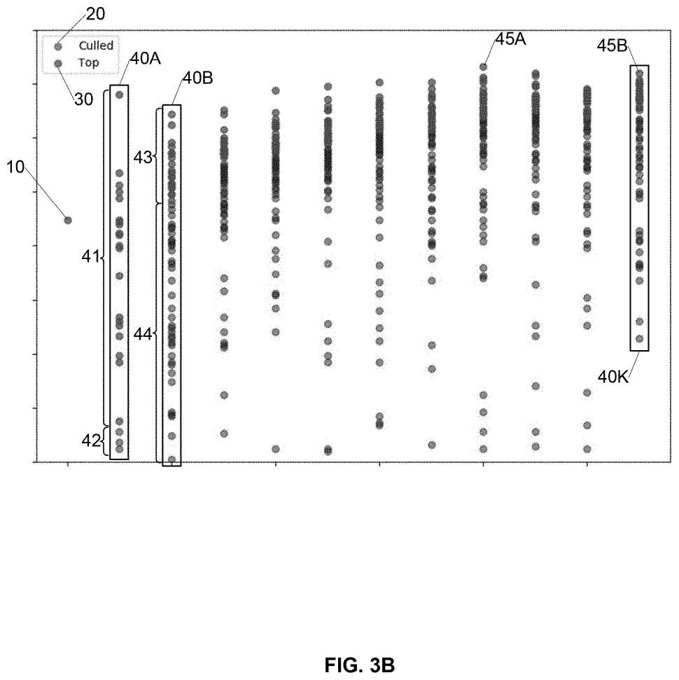

FIGS. 3A-3B are graph diagrams illustrating an example progressive optimization of a densely connected neural network 10 over multiple generations (40A-40K) of automated revision and evaluation according to an embodiment. In the illustrated embodiment, the initial neural network 10 is evaluated based on the MNIST “digit recognition” benchmark. The characteristics of the initial neural network 10 are used to seed the first generation of candidate neural networks 40A. The characteristics may include the architecture of the neural network and the hyperparameters and the respective value of the hyperparameters.

As shown in FIG. 3B, each candidate neural network it the first generation 40A is represented by a single dot and each candidate neural network it the first generation 40A comprises values of hyperparameters that are mutated from the values of hyperparameters initial neural network 10. For example, a first hyperparameter in the initial neural network 10 has a first value, which results in a first hyperparameter-value pair. Accordingly, a first candidate neural network has a first hyperparameter-value pair for the same first hyperparameter, but having a value that is different from the value in the first hyperparameter-value pair of the initial neural network 10. Similarly a second candidate neural network has a first hyperparameter-value pair for the same first hyperparameter, but having a value that is different from the value in the first hyperparameter-value pair of the initial neural network 10 and different from the first hyperparameter-value pair of the first candidate neural network. In this fashion, a plurality of candidate neural networks with modified hyperparameter-value pairs are created as part of the first generation 40A of candidate neural networks.

After the first generation 40A of candidate neural networks is created, they are trained and operated and evaluated to identify the top performing candidate neural networks 41 and top performing hyperparameter-value pairs in the first generation 40A. The lowest performing candidate neural networks 42 are culled from the first generation 40A and the remaining top performing candidate neural networks 41 and top performing hyperparameter-value pairs in the first generation 40A are then used to seed the characteristics of a second generation 40B of candidate neural networks. The second generation 40B of candidate neural networks also includes one or more candidate neural networks having mutated values for certain hyperparameter-value pairs. The second generation 40B of candidate neural networks is similarly trained and operated and evaluated to identify the top performing candidate neural networks 43 and top performing hyperparameter-value pairs in the second generation 40B and the lowest performing candidate neural networks 44 in the second generation 40B are culled.

The process of creating a generation of candidate neural networks based on the top performers of the prior generation and then training, operating, evaluating and culling iterates through a plurality of generations until an optimized neural network is determined, for example 45A or 45B in FIG. 3B.

In the illustrated embodiment, the initial neural network 10 performed with an accuracy of 97.62% on the MNIST “digit recognition” benchmark and the final optimized neural network 45A or 45B performed with an improved accuracy of 98.32%. Accordingly, the accuracy of the initial neural network 10 was automatically improved by an unsupervised application of the system to an already successfully performing densely connected neural network 10.

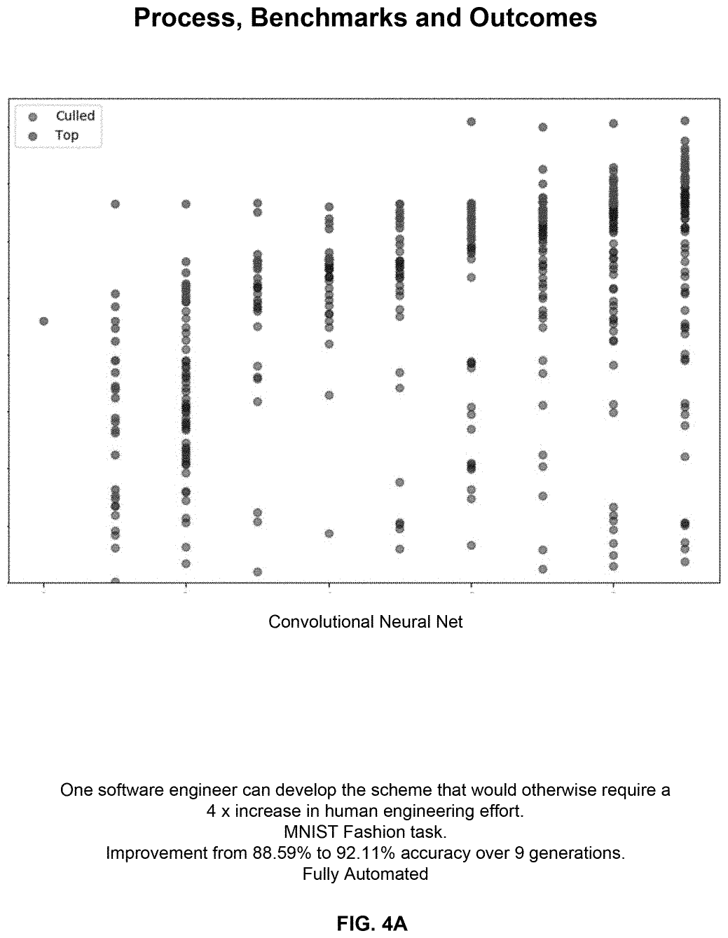

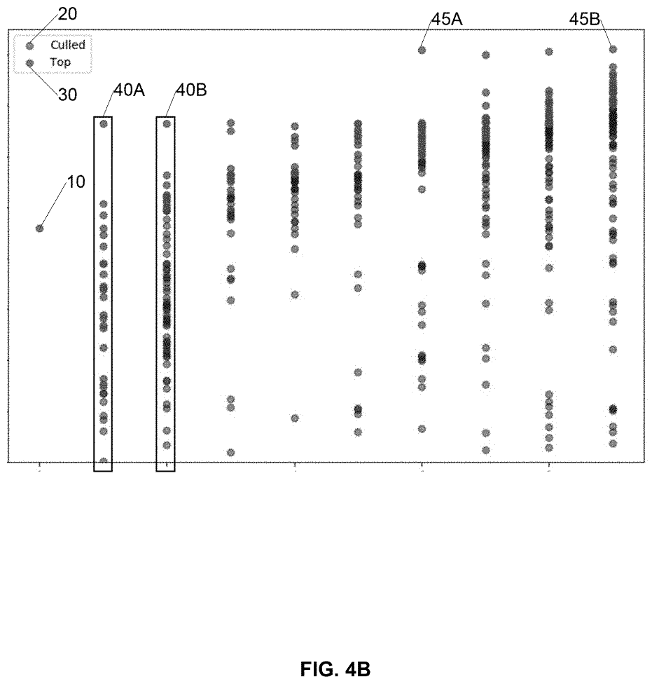

FIGS. 4A-4B are graph diagrams illustrating an example progressive optimization of a convolutional neural network 10 over multiple generations of automated revision and evaluation according to an embodiment. In the illustrated embodiment, the initial neural network 10 is designed to perform the MNIST fashion task. Applying the same unsupervised automated process described with respect to FIGS. 3A-3B, in the illustrated embodiment, the accuracy of the initial neural network 10 was automatically improved from 88.59% to 92.11% by an application of the system to an already successfully performing convoluted neural network 10.

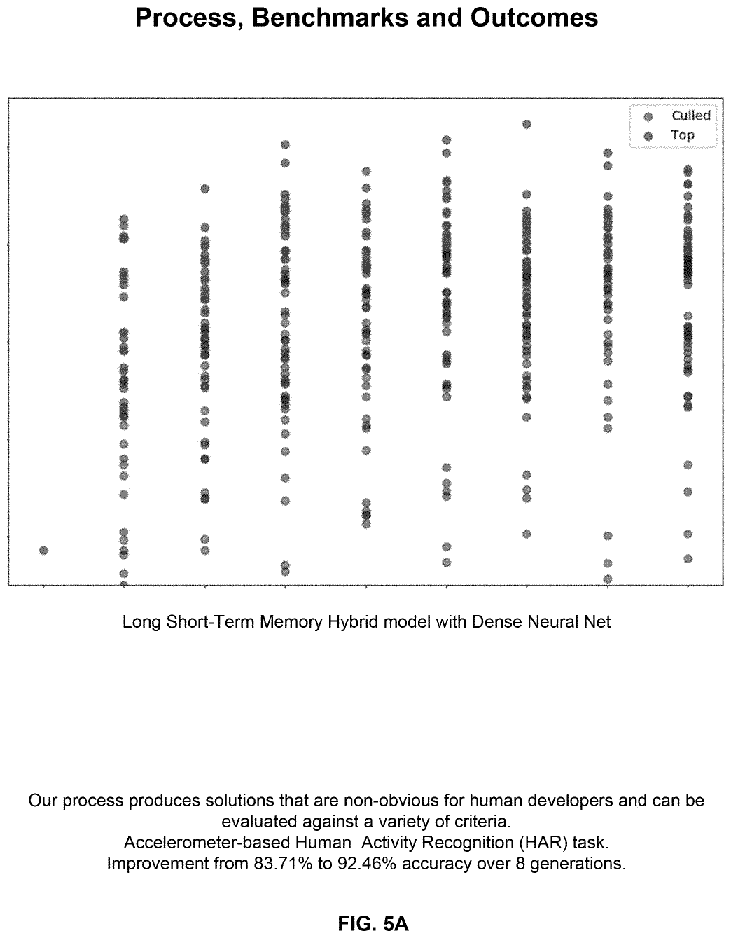

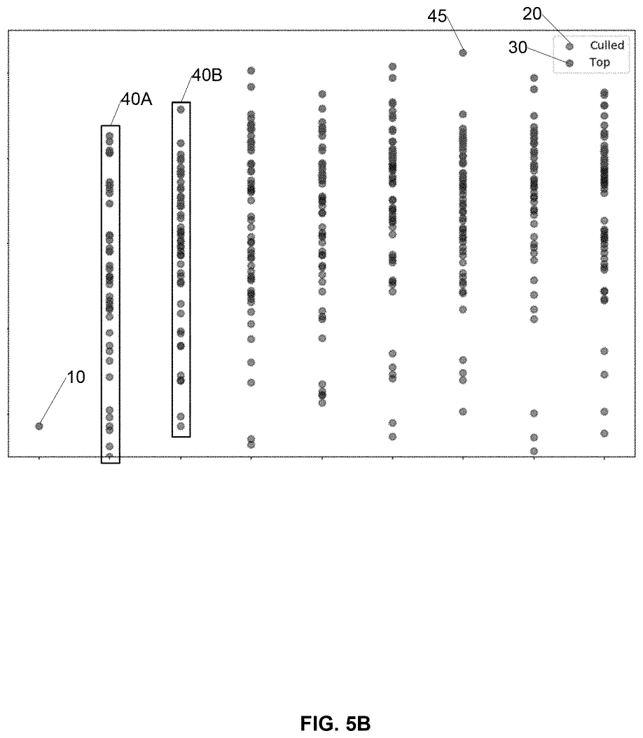

FIGS. 5A-5B are graph diagrams illustrating an example progressive optimization of a hybrid long short-term memory and dense neural network 10 over multiple generations of automated revision and evaluation according to an embodiment. In the illustrated embodiment, the initial neural network 10 is designed to work with sequential data, in this particular example, time series accelerometer data for a human activity recognition task. Applying the same previously described unsupervised automated process, in the illustrated embodiment the accuracy of the initial neural network 10 was automatically and significantly improved from 83.71% to 92.47% by an application of the system to an already successfully performing convoluted neural network 10.

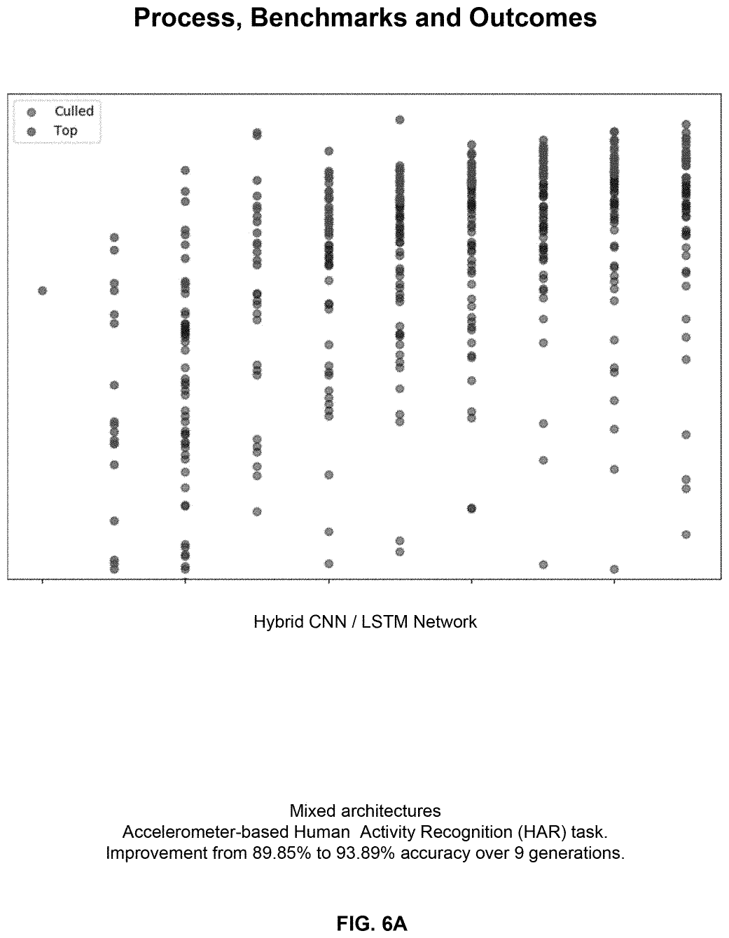

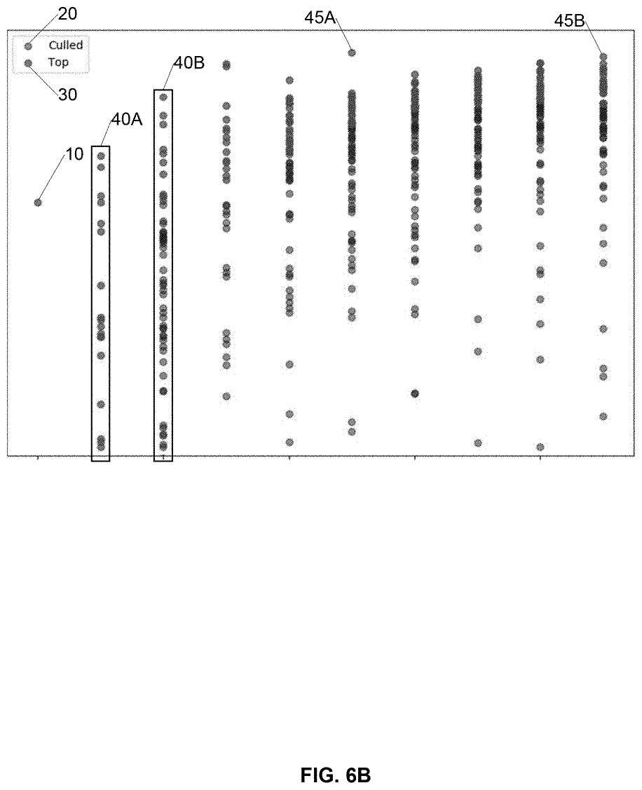

FIGS. 6A-6B are graph diagrams illustrating an example progressive optimization of a hybrid long short-term memory and convolutional neural network 10 over multiple generations of automated revision and evaluation according to an embodiment. In the illustrated embodiment, the initial neural network 10 is designed to work with the same time series accelerometer data for a human activity recognition task, however the architecture of the initial neural network 10 is a hybrid architecture. Advantageously, the system described herein is capable of operating with mixed architecture neural networks, such as t initial hybrid CNN and LSTM neural network 10. Applying the same previously described unsupervised automated process, in the illustrated embodiment the accuracy of the initial neural network 10 was automatically improved from 89.85% to 93.89% by an application of the system to an already successfully performing convoluted neural network 10.

### Example Embodiments

As explained above with respect to FIGS. 3A-6B, the operational accuracy of existing neural networks can be improved by iterative mutation and evaluation of the hyperparameter-value pairs of an initial neural network that is already highly functional. Similarly, a new, highly accurate neural network can be created for a particular task by initial selection of random characteristics for an initial candidate neural network followed by iterative mutation and evaluation of the hyperparameter-value pairs of the initial candidate neural network. In one embodiment, the architecture and/or accuracy of neural networks that are used to demonstrate the effectiveness of neural networks can be improved. One particular advantage of the presently disclosed systems and methods is the creation of very high performing neural networks using very minimal manpower where the skilled professional is only needed to specify very high level characteristics of the desired outcomes of application of the neural network. For example, such high level characteristics may include performance criteria such as accuracy of task, computational resources used by the neural network, time to produce a solution, and the computational resource used in the tuning process.

In one embodiment, implementations of the present disclosure can be used to create software for a wide range of applications. Such software can be used to identify objects in still images or motion images, specific components in sound, and letters or words in text, just to name a few applications. Such software can be used to identify activities in still images, motion images, or audio. Such software can be used to characterize meaning in still images, motion images, audio or text. Such software can be used to identify patterns of information in documents such as medical records, or other kinds of records that have either single types of data or multiple types of data such as text, numbers and images. Such software can be used to generate images, motion images, audio, text, or numeric information. Such software can be used to find correlations between, across and within all of these data types.

These beneficial capabilities of example embodiments of the present disclosure can be implemented in connection with devices in the physical world such as sensors and actuators to bring data in and effect action upon the physical world. For example, sensors can include (but are not limited to) items such as cameras, microphones, biometric sensors (heart rate, breath rate, body temperature, skin salinity, etc.), environmental sensors (temperature, humidity, atmospheric gas levels, air pressure, soil pH), and other types of sensors. For example, actuators can include (but not limited to) items such as single action devices, autonomous transportation devices, mobile robots, stationary robots, and flying robots, just to name a few. All of the above described sensors and actuators can be implemented in an individual, stand-alone fashion or integrated with other systems.

FIG. 7 is a block diagram illustrating an example processor enabled wired or wireless system 550 that may be used in connection with various embodiments described herein. For example the system 550 may be used as or in conjunction with a computational system as previously described with respect to FIGS. 1-6B. The system 550 can be a computer server, a personal computer, personal digital assistant, smart phone, tablet computer, or any other processor enabled device that is capable of executing programmed modules and capable of wired or wireless data communication. Other computational systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display 587. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A system for optimizing a neural network designed to perform a specific task, the system comprising:
a non-transitory computer readable medium configured to store executable programmed modules;
a processor communicatively coupled with the non-transitory computer readable medium and configured to execute programmed modules stored therein, wherein the processor is programmed to:
identify one or more architectures for each of a plurality of first generation candidate neural networks;
identify a plurality of hyperparameters;
generate a plurality of hyperparameter-value pairs, wherein a first hyperparameter-value pair has a first hyperparameter and a first value and the first hyperparameter-value pair is assigned to a first candidate first generation neural network and wherein a second hyperparameter-value pair has the first hyperparameter and a second value, different from the first value and derived by mutating the first value, and the second hyperparameter-value pair is assigned to a second candidate first generation neural network;
create the plurality of first generation candidate neural networks based on the identified architectures and the generated plurality of hyperparameter-value pairs;
train the plurality of first generation candidate neural networks;
subsequent to training, operate the plurality of first generation candidate neural networks;
evaluate performance of each of the plurality of first generation candidate neural networks in accordance with one or more fitness functions;
determine one or more of top performing architectures, top performing first generation candidate neural networks, and top performing hyperparameter-value pairs;
create a plurality of second generation candidate neural networks based on one or more of the determined top performing architectures, top performing first generation candidate neural networks, and top performing hyperparameter-value pairs;
train the plurality of second generation candidate neural networks;
subsequent to training, operate the plurality of second generation candidate neural networks;
evaluate performance of each of the plurality of second generation candidate neural networks in accordance with the one or more fitness functions; and
identify an optimized neural network for performing the specific task based on the performance evaluation.

2. The system of claim 1, wherein the number of generations of candidate neural networks is greater than 1000.

3. A method for optimizing a neural network to perform a specific task comprising:
identifying one or more architectures for each of a plurality of first generation candidate neural networks;
identifying a plurality of hyperparameters;
generating a plurality of hyperparameter-value pairs, wherein a first hyperparameter-value pair has a first hyperparameter and a first value and the first hyperparameter-value pair is assigned to a first candidate first generation neural network and wherein a second hyperparameter-value pair has the first hyperparameter and a second value, different from the first value and derived by mutating the first value, and the second hyperparameter-value pair is assigned to a second candidate first generation neural network;
creating the plurality of first generation candidate neural networks based on the identified architectures and the generated plurality of hyperparameter-value pairs;
training the plurality of first generation candidate neural networks;
subsequent to training, operating the plurality of first generation candidate neural networks;
evaluating performance of each of the plurality of first generation candidate neural networks in accordance with one or more fitness functions;
determining one or more of top performing architectures, top performing first generation candidate neural networks, and top performing hyperparameter-value pairs;
creating a plurality of second generation candidate neural networks based on one or more of the determined top performing architectures, top performing first generation candidate neural networks, and top performing hyperparameter-value pairs;
training the plurality of second generation candidate neural networks;
subsequent to training, operating the plurality of second generation candidate neural networks;
evaluating performance of each of the plurality of second generation candidate neural networks in accordance with the one or more fitness functions; and
identifying an optimized neural network for performing the specific task based on the performance evaluation.

4. The method of claim 3, wherein the number of generations of candidate neural networks is greater than 1000.
